(19) United States
(12) Patent Application Publication
(10) Pub. No.: US 2006/0266354 A1
(43) Pub. Date: Nov. 30, 2006

(54) Treatment for hepatitis

(76) Inventor: Stephen D. Guthrie, Mineola, NY (US)

Correspondence Address: SETO PATENTS, 406 RIVERLAND DR., SALEM, VA, 24153, US

(21) Appl. No.: 11/208,402

(22) Filed: Aug. 19, 2005

Related U.S. Application Data
(60) Provisional application No. 60/685,110, filed on May 27, 2005.

(51) Int. Cl. A61G 10/00; A62B 31/00

(52) U.S. Cl. 128/202.12; 128/830; 128/205.26

(57) ABSTRACT

A system for administering a treatment to individuals infected with a virus such as hepatitis. The system includes an enclosure and at least one gas supply that is used to create an altered atmospheric environment within the enclosure. The patients walk into the enclosure, the super-atmospheric environment is created with the gas, and the patients remain in the super-atmospheric environment for a predefined length of time. The individuals are subsequently returned at a safe rate to normal atmospheric pressure. The treatment can be repeated daily, monthly or annually depending on the needs of the patient. The system includes a control unit that stores and runs at least one treatment program that helps determine treatment variables such as amount of pressure, length of time and the type of gas or gases. It is believed that the present viral treatment may be able to be used in combination with medications and other viral treatments.

The present invention was originally disclosed in U.S. provisional patent application Ser. No. 60/685,110 filed on May 27, 2005, and priority is claimed to the provisional patent application.

### BACKGROUND OF THE INVENTION

The present invention relates generally to the field of treatment of viruses and more specifically to a novel treatment for hepatitis.

Viruses are infectious agents found in virtually all life forms, including humans, animals, plants, fungi, and bacteria. Viruses consist of genetic material, either deoxyribonucleic acid (DNA) or ribonucleic acid (RNA), surrounded by a protective coating of protein, called a capsid. Some viruses also include an outer lipid envelope. Viruses are between 20 and 100 times smaller than bacteria and hence are too small to be seen by light microscopy. Viruses vary in size from the largest poxviruses of about 450 nanometers (about 0.000014 in) in length to the smallest polioviruses of about 30 nanometers (about 0.000001 in). Viruses are not considered free-living, since they cannot reproduce outside of a living cell. Viruses have evolved so that they are able to inject their genetic information into a host cell and use the host cell's internal machinery for the purpose of replication.

Viruses often damage or kill the cells that they infect, thereby causing disease in infected organisms. A few viruses stimulate cells to grow uncontrollably and produce cancers. Although many infectious diseases, such as the common cold, are caused by viruses, there are no cures for these illnesses. The difficulty in developing antiviral therapies stems from the large number of variant viruses that can cause the same disease, as well as the inability of drugs to kill a virus without also killing healthy cells.

Hepatitis A is a liver disease caused by the hepatitis A virus. Hepatitis A can affect anyone. In the United States, hepatitis A can occur in situations ranging from isolated cases of disease to widespread epidemics. Good personal hygiene and proper sanitation can help prevent hepatitis A. Vaccines are also available for long-term prevention of hepatitis A virus infection in persons 2 years of age and older. Immune globulin is available for short-term prevention of hepatitis A virus infection in individuals of all ages.

Hepatitis B is a serious liver disease caused by the hepatitis B virus (HBV). The hepatitis B virus can cause lifelong infection, cirrhosis (scarring) of the liver, liver cancer, liver failure, and death. Hepatitis B vaccine is available for all age groups to prevent hepatitis B virus infection.

Hepatitis C is a disease of the liver caused by the hepatitis C virus (HCV). Those at risk for hepatitis C include those that: have been notified that they received blood from a donor who later tested positive for hepatitis C; have ever injected illegal drugs; received a blood transfusion or solid organ transplant before July, 1992; were a recipient of clotting factor(s) made before 1987; have ever been on long-term kidney dialysis; and, have evidence of liver disease (e.g., persistently abnormal ALT levels).

Hepatitis D is a liver disease caused by the hepatitis D virus (HDV), a defective virus that needs the hepatitis B virus to exist. Hepatitis D virus (HDV) is found in the blood of persons infected with the virus.

Hepatitis E is a liver disease caused by the hepatitis E virus (HEV) transmitted in much the same way as hepatitis A virus. Hepatitis E, however, does not occur often in the United States. While vaccines are available for some of the hepatitis viruses, the vaccines only prevent a healthy individual from becoming infected with the virus. Once an individual is infected with the virus, the currently available treatments provide only limited effectiveness.

Applicant's research, in a related field, showed that exposing patients to super-atmospheric conditions strengthened the patients' immune systems. Atmospheric pressure can be thought of as the amount of pressure the environment surrounding an individual exerts on the individual. If the person is at sea-level elevation, meaning zero elevation, the person will experience approximately 1 atmosphere (atm) of pressure. A super-atmospheric condition exists when the atmospheric pressure is above 1 atmosphere (atm). Super-atmospheric conditions exist in nature, such as underwater, and can also be created artificially, such as in the fuselage of passenger airliners during flight. Hyperbaric chambers have traditionally been used to treat scuba divers that ascended from their dive too fast and subsequently come down with a painful syndrome called the bends, wherein nitrogen gas bubbles are created in the diver's bloodstream. Hyperbaric chambers are another example of artificially created super-atmospheric conditions. In the case of the bends, the hyperbaric chamber recreates the super-atmospheric pressure that the diver was under while diving. In the super-atmospheric conditions, the nitrogen is allowed to safely diffuse back into the diver's body. Most of the nitrogen is removed from the diver's body through normal respiration. Traditional hyperbaric chambers are simple one-room air locks that can be pressurized with regular air. Newer chambers that provide for the introduction of oxygen, have found widespread use in the treatment of wound healing. Traditional wound healing, using oxygen under pressure, is conducted within an environment of 2.4 atm, which is equal to a depth of 45 feet.

What is needed in the field is a comprehensive system that can support testing the efficacy of treating the many forms of Hepatitis as well as other viruses with super atmospheric conditions. The ideal system would be able to treat a large number of patients at a relatively low cost.

### SUMMARY OF THE INVENTION

A system that is adapted to strengthen the immune system of an individual. The system comprises an enclosure, a gas supply, a monitoring network and a control system. The enclosure has at least one air-lock that is able to sustain super-atmospheric conditions. The gas supply includes gas supply hardware that connects the gas supply to the enclosure. The gas supply may include one gas or a combination of gases. The monitoring network is used to monitor the statuses of the enclosure, the gas supply, and the gas supply hardware. The control system is connected to the monitoring system and includes at least one display screen that is capable of displaying the statuses of the different parts of the system. The control system also includes at least one processor and at least one memory. The control system is capable of controlling the pressure and the concentration of gas in the enclosure. A treatment program can be temporarily stored in the memory of the control system and executed by the processor. The treatment program is associated with a content of the gas supply, and can be used to define the pressure to be achieved within the enclosure and the duration of time for maintaining the pressure.

The enclosure may comprise multiple air-locks wherein each air-lock is connected to the monitoring network and to the gas supply. The control system is able to control the pressure within each air-lock. The pressures can range from below atmospheric to many times greater that atmospheric pressure. The system may also include more than one gas supply, wherein each gas supply is connected to the gas supply hardware, the monitoring network and the control system. The control system can control the concentration of gas in each of the multiple air-locks. The control system also preferably includes a permanent storage device and the treatment program can be stored on the permanent storage device. The control system may optionally include an Internet connection and a remote control software module that allows a remotely located computer to access and control the system via the Internet. The pressures within the enclosure may range between 0.75 to 20 or more atmospheres, and the duration of time for sustaining the pressure is preferably between 15 and 60 minutes.

It is an object of the present invention to provide a treatment that strengthens a person's immune system so that the person's immune system is better able to fight off diseases, especially viral diseases.

It is another object of the present invention to provide an apparatus for administering the present treatment.

It is a further object to provide an apparatus that will create an environment of predetermined gas mixtures and surrounding pressure that will enhance the administration of therapeutics agents or other efficacious treatments.

### BRIEF DESCRIPTION OF THE DRAWINGS

The invention of the present application will now be described in more detail with reference to the accompanying drawings, given only by way of example, in which:

FIG. 1 shows an exemplary apparatus for administering the present treatment;

FIG. 2 shows a mobile apparatus for administering the present treatment;

FIG. 3 shows an alternative apparatus for administering the present treatment;

FIG. 4 shows another alternative apparatus for administering the present treatment; and,

FIG. 5 is a flow chart showing exemplary steps of the present treatment.

### DETAILED DESCRIPTION OF THE INVENTION

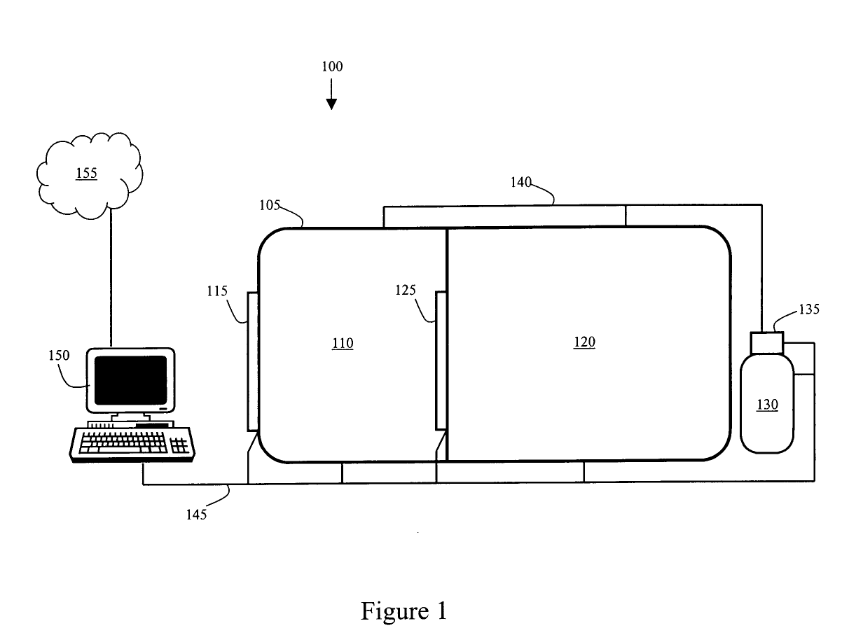

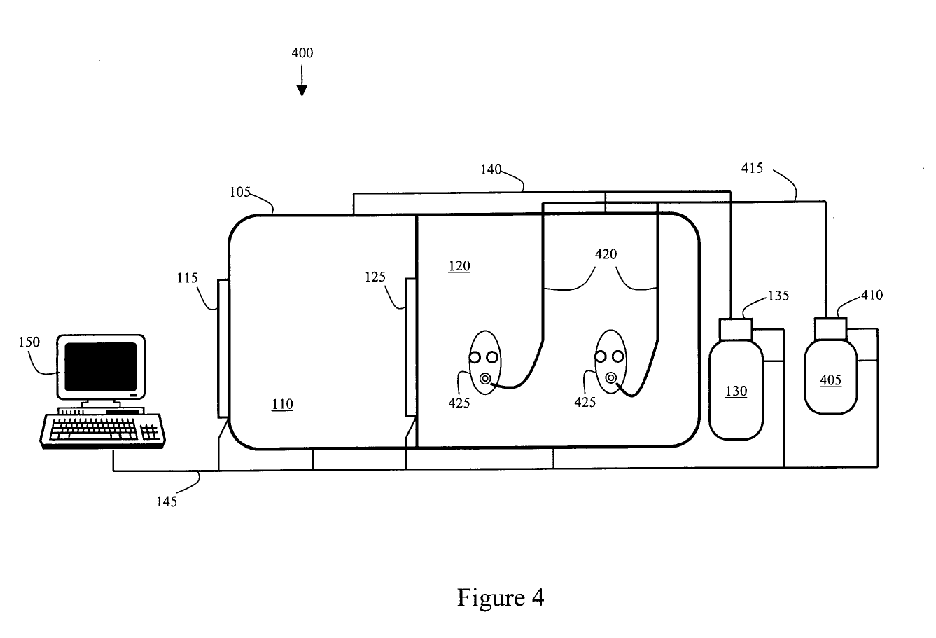

FIG. 1 shows an exemplary apparatus 100 for administering the present viral treatment. Enclosure 105 is used to create a super-atmospheric environment, which is the preferred delivery means for the present treatment. The enclosure 105 includes a first air-lock 110 and a second air-lock 120. Each air-lock 110 and 120 is a room that is capable of being sealed and pressurized to at least 10 atmospheres, which is equal to a depth of approximately 300 feet. The second air-lock 120 is the primary treatment room and preferably includes beds, benches or chairs for the patients to use during the treatment. The first air-lock 110 is a safety room that allows an assistant to enter to the second air-lock 120, if needed. The patients enter the enclosure 105 through seal-able door 115 and then enter the second air-lock 120, or treatment room, through a second seal-able door 125. Once the patients are inside the second air-lock 120 the seal-able door 125 is closed and sealed. Control unit 150 is then used to start the flow of gas from the gas supply 130 into the second air-lock 120. Control unit 150 sends a “start” signal to the gas flow switch 135, which starts the flow of gas through the gas flow pipe 140 into the treatment room, air-lock 120. Gas flow switch 135 and gas flow pipe 140 can collectively be referred to as the gas supply hardware. Control unit 150 is preferably programmed with the atmospheric pressure to be obtained and automatically sends a “stop” signal to the gas flow switch 135 when the desired pressure has been obtained inside the second air-lock 120. A control and monitoring network 145 connects the control unit 150 to a set of sensors and to the gas flow switch. At least one sensor is provided inside each of the air-locks 110 & 120 in the enclosure 105. The sensors inside the air-locks provide information, including interior pressure and gas concentrations, to the control unit 150. Other sensors are used to monitor the statuses of the seal-able doors 115 & 125, the gas supply 130, the gas flow switch 135, and within the gas delivery hoods that are discussed in conjunction with FIG. 4. All information received from the sensors can be displayed on the screen of the control unit 150. Of course, the control unit 150 may also include LED lights and analog gauges to display the sensor information. Once the desired pressure and gas concentration has been obtained in the second air-lock 120, the patients remain in the air-lock 120 for a predefined length of time. The present treatment includes the use of pressures that are three and four times greater than current therapies. The predefined length of time is determined by the treatment program and is based on the pressure and gas, or gas mixture, to be used during the treatment. The control unit 150 can be programmed with the desired length of time so that at the end of the desired length of time an alert is sounded and/or displayed indicating it is time to start decompression. When the desired length of time has passed, the pressure inside the second air-lock 120 is slowly released so that the patients are safely returned to a normal atmospheric environment (1 atmosphere). Preferably, decompression is started automatically by the control unit 150 at the end of the predefined length of time. Decompression tables that define safe decompression rates are widely available. The control unit 150 is preferably programmed with at least one of these decompression tables and uses this stored information to control the rate at which the pressure is released from the second air-lock 120. Once the environment within the second air-lock 120 has been reduced to normal, the sealable doors 125 & 115 can be opened and the patients are free to exit the enclosure 105. Gas supply 130 preferable contains nitrogen gas. However, other gases and combination of gases may also be used. The amount of oxygen in the second air-lock 120 at the beginning of the treatment is usually enough to sustain the needs of the patients. This is true because the percentage of oxygen required by humans is inversely proportional to the atmospheric pressure. Thus, as the pressure increases in the air-lock 120 the percentage of oxygen required by the patients decreases. Of course, the amount of oxygen in the air-lock 120 may be supplemented when needed, as in when large numbers of patients are treated at the same time or when the patients spend an extended length of time in the air-lock. The current preferred length of time for remaining in the super-atmospheric environment is approximately 40 minutes. However, it is believed that shorter lengths of time at pressure will also prove to be useful. The preferred super-atmospheric environment is at least 5 atmospheres. However, it is anticipated that higher super-atmospheric environments will also prove to be beneficial.

The control unit 150 may also be connected to a network 155 such as the Internet. Connection to a network 155 allows monitoring of the present treatment from remote locations. The control unit 150 may also include a remote control software module that further allows the apparatus 100 to be controlled from a remote location. The control unit 150 preferably includes a treatment program that defines all of the steps for carrying out the present treatment. In the preferred embodiment, after the patients have entered the treatment room, an administrator simply presses a button on the control unit 150 and the desired treatment is automatically administered by the apparatus 100 under the control of the control unit 150. Of course, whether the control unit is operated locally or remotely, an administrator should always be present to handle any emergencies and to provide instructions to the patients. The present treatment is directed toward combating the various forms of Hepatitis. However, the treatment may also be used to combat other viruses as well. It is believed that, under pressure, atoms in the gas strengthen potential host cells in the patient and prevent the virus from taking over the replication machinery of the host cells and thereby prevents the virus from replicating. While the virus may be able to attach to the cell wall of a host cell and inject its genetic information into the host cell, once inside, the present treatment prevents the virus' genetic information from taking control of the replication hardware of the cell, as normally occurs. Mammalian cells have evolutionarily developed an inherent mechanism (the “silencing RNA”, or iRNA apparatus) to sequester potentially damaging viral genetic material and preclude their fatal consequences. It is possible that the present treatment/apparatus may simply be harnessing that corrective capacity within the invaded cell. Applicant further proposes that the present treatment also strengthen the walls of the host cells thereby stopping the virus before it even enters the host cell. It is believed that the present treatment strengthens cell walls to the point that viruses are simply unable to penetrate the cell walls and inject their genetic material for subsequent replication. In either case, the virus is prevented from replicating and the number of virus particles in the patient's body eventually decreases and the patient's immune system is able to effectively deal with the remaining virus particles.

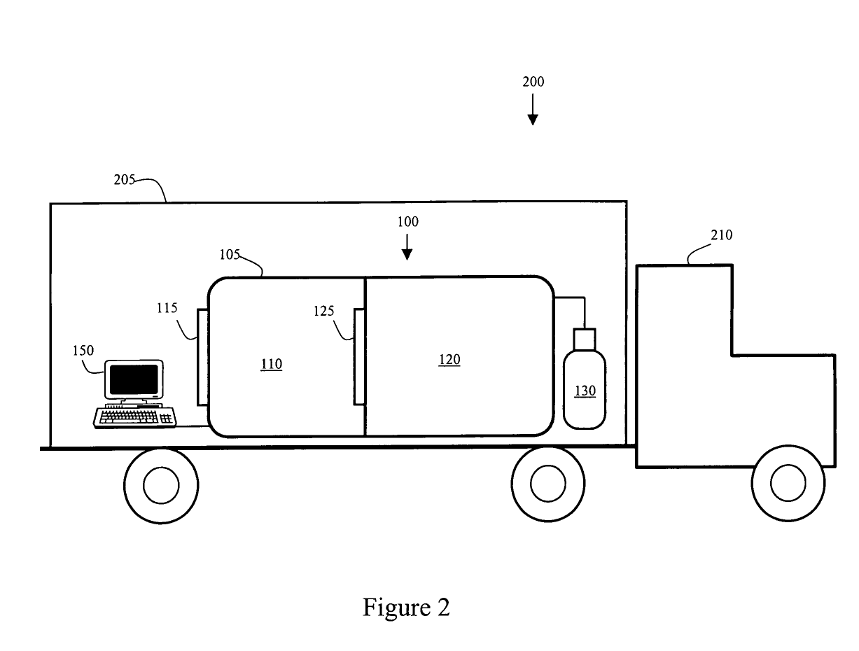

FIG. 2 shows a mobile apparatus 200 for administering the present treatment. The mobile apparatus 200 comprises tractor 210 and trailer 205, which are used to transport the exemplary apparatus 100. The mobile apparatus 200 can be used to treat viral patients in remote areas where the local population does not have access to traditional treatment facilities. The trailer 205 can be enclosed, as is shown in FIG. 2, or the trailer could also be a simple flatbed trailer, in which case the exemplary apparatus 100 would be exposed for passersby to see. The exemplary apparatus 100 is used to administer the present treatment in the same manner as described above, with the gas supply 130 being used to create a super-atmospheric environment within air-lock 120, while all operations are monitored and controlled by the control unit 150.

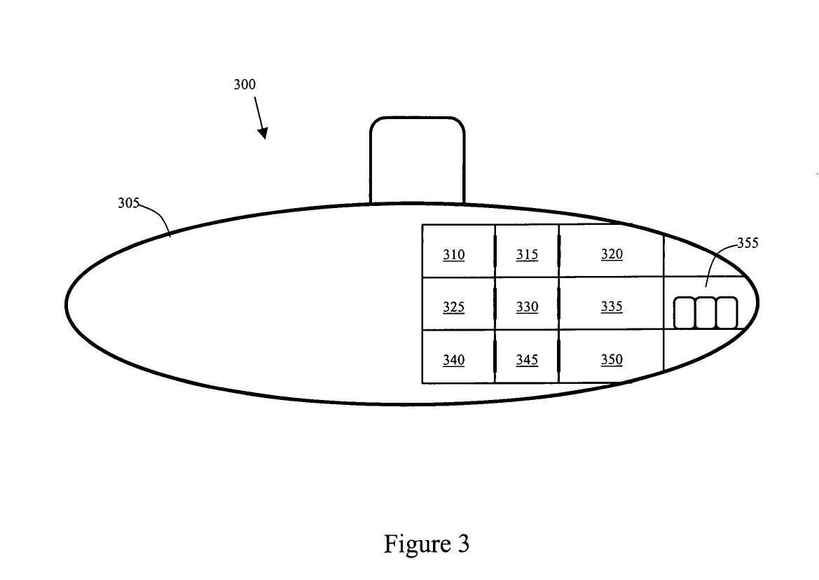

FIG. 3 shows an alternative apparatus 300 for administering the present viral treatment. In FIG. 3, a submarine 305 is used to provide multiple enclosures for creating super-atmospheric environments. A submarine 305 is a good choice for treating large numbers of patients because submarines are large and they are built for withstanding great amounts of pressure. In this example, three levels of the submarine 305 are used to provide three separate treatment facilities. Air-locks 315 & 320 are provided on the top level and control room 310 is used to monitor and control the operations of the air-locks 315 & 320 on the top level. Air-locks 330 & 335 are provided on the middle level and control room 325 is used to monitor and control the operations of the air-locks 330 & 335 on the middle level. Air-locks 345 & 350 are provided on the bottom level and control room 340 is used to monitor and control the operations of the air-locks 345 & 350 on the bottom level. The gas supplies 355 for the multiple air-locks are consolidated on the middle level in this example. In other embodiments, the gas supplies can be distributed so that they are co-located with the air-locks that they service. The gas supply hardware and the control and monitoring network are not shown for clarity purposes, however each air-lock is connected to the gas supply 355 and each air-lock is also connected to a control and monitoring network. The primary treatment rooms, air-locks 320, 335 & 350, can each be used independently to provide different treatments, meaning different pressures, different gas concentrations and different lengths of time at pressure. Alternatively, control room 310 could be used to control the operations of all of the air-locks, so that a large number of patients can be treated with a relatively small number of staff personnel, or administrators. The treatment provided by this alternative apparatus 300 is the same as that described above, with at least one gas being used to create a super-atmospheric environment and having the patients remain in the super-atmospheric environment for a predefined length of time.

FIG. 4 shows another alternative apparatus 400 for administering the present treatment. Apparatus 400 is a modification of the exemplary embodiment 100 shown in FIG. 1. In apparatus 400, a second gas supply 405 is provided. The second gas supply 405 is fed to the air-lock 120 where the patients are located, via flow switch 410 and flow pipe 415. The second gas is delivered directly to the patients via supply tubes 420 and gas delivery hoods 425. The apparatus 400 of FIG. 4 can be used when the gas to be inhaled by the patients is an expensive gas or gas mixture. In this case, a less expensive gas, such as air, is used in gas supply 130 to pressurize the interior of air-lock 120. The more expensive gas from the second gas supply 405 is then delivered directly to the patients via hoods 425. The direct delivery device is preferably a hood that substantially covers the head of the patient. However, the direct delivery device could be a partial hood or, a full or partial mask that is connected to the supply tubes 420. This variation on the present gas administration treatment also allows sensor monitoring of an individual patient's gas and the incorporation of a gas-retrieval device to recover exhaled gases when extremely expensive (or short supply) gases are being breathed.

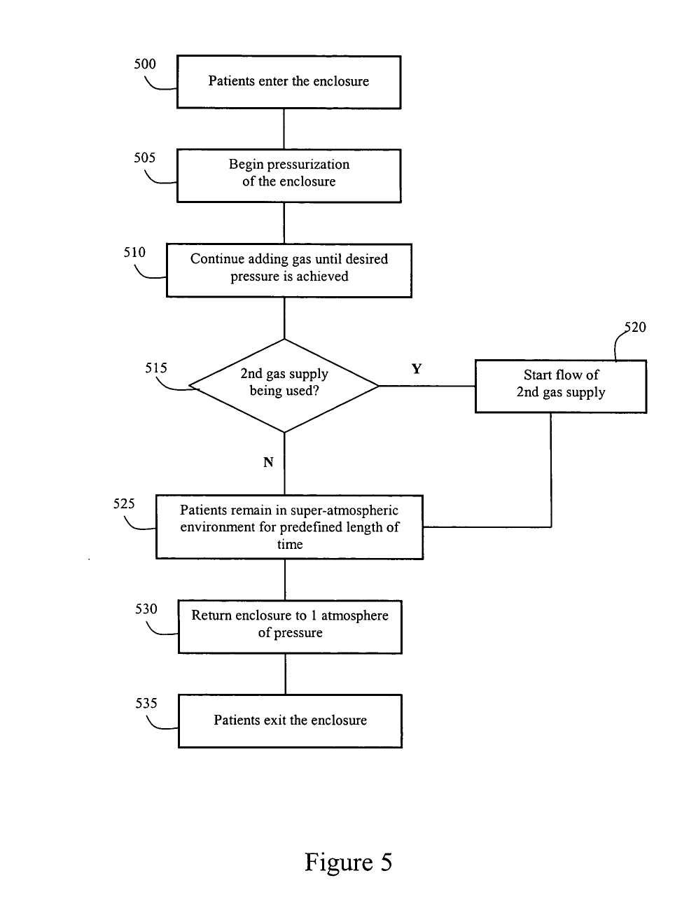

FIG. 5 is a flow chart showing exemplary steps of the present viral treatment. In step 500 the patient or patients enter the enclosure, have a seat in the treatment room, the door to the air-lock is closed and the treatment room is sealed. Each patient has previously been screened to make sure they are healthy enough to endure the super-atmospheric conditions to which they will be exposed, and so that the amount of virus in their body, called their viral load, is known. In step 505, a gas or gas mixture is added to the enclosure and pressurization begins. The preferred gas is a specific non-air gas mixture, however a single gas and combinations of gases may also be used in other embodiments. In step 510, the gas is continually added until a desired super-atmospheric environment is achieved within the enclosure. The present treatment may require creating a super-atmospheric condition that is equal to a diving depth of over 250 feet. In step 515, the treatment program checks to see if a second gas supply is required. If a second gas supply is to be used, then the flow of the second gas is started in step 520. If there is no second gas to be used, then the program moves to step 525, in which the patients remain in the enclosure, within the super-atmospheric environment, for a predefined length of time. The current preferred length of time is 40 minutes however, other lengths of time may be used and similar results may be achieved by using higher pressures, and/or different gas mixtures, for shorter lengths of time. For example, a super-atmospheric environment of 6 atmospheres may achieve similar results with only 20 minutes of exposure. In step 530, after the predefined length of time has passed, the enclosure is returned to normal pressure, 1 atmosphere. The pressure is released from the enclosure at a rate that is consistent with well-known decompression tables so that the patients are not harmed. In order to insure there are no incidences of decompression sickness, or the bends, operators of the present system will have to be trained and certified for its operation. Certification may include training in various changes in a compression-decompression “profiles” mandated by the composition of the specific gas mixture employed. In step 535, the doors of the enclosure are opened, the patients walk out the enclosure and their treatment is over for that day. It may be possible to treat a patient with only one exposure to the super-atmospheric environment, however the preferred treatment regimen dictates that daily exposures be repeated for five to seven days. Treatments can be personalized and some patients may require more or less days of exposure. Depending on the effectiveness of the above method, some patients may require exposures that are repeated monthly or yearly.

The therapeutic gases used the present treatment have the ability to cross the blood-brain barrier and therefore is able to treat all areas of the patient's body. Current retroviral therapies do not have this ability. The present treatment may also be used in combination with other viral therapies. It is believed that by augmenting traditional therapies, such as prescribed drugs, with the present treatment that the patient may be able to reduce the total amount of prescribed drugs needed to maintain his health. With the severe side effects associated with many prescription drugs, any reduction in the total number of pills the patient has to take every day will greatly benefit the patient.

The foregoing description of the specific embodiments will so fully reveal the general nature of the invention that others can, by applying current knowledge, readily modify and/or adapt for various applications such specific embodiments without departing from the generic concept. For example, the control unit and the gas supply could be integrated with the enclosure to provide a single unit for carrying out the present treatment. Further, the enclosure is not required to have rounded corners and, structures that resemble traditional buildings could also be used as the enclosure. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A system that is adapted to strengthen an immune system(s) of one or more patients, the system comprising:
an enclosure having at least one air-lock that is able to sustain a super-atmospheric environment;
a first gas supply that contains one or more gases;
a gas supply hardware, the gas supply hardware connecting the first gas supply to the enclosure;
a monitoring network that is electrically connected to the enclosure, the gas supply and the gas supply hardware, wherein the monitoring network monitors a status of the enclosure, a status of the gas supply, and a status of the gas supply hardware;
a control system that is electrically connected to the monitoring system, the enclosure and the gas supply hardware, the control system having at least one display screen, at least one processor, and at least one memory, wherein the control system is capable of controlling, and displaying the statuses of, the enclosure, the first gas supply and the gas supply hardware; and,
a treatment program that is at least temporarily stored in the memory and executed by the processor, wherein the treatment program is associated with a content of the first gas supply, and the treatment program defines the super-atmospheric environment to be sustained by the enclosure and a duration of time for sustaining the super-atmospheric environment within the enclosure.

2. The system of claim 1, wherein the enclosure comprises 6 or more air-locks and each air-lock is connected to the monitoring network and to the gas supply hardware, and further wherein the control system is able to control a pressure within each air-lock.

3. The system of claim 2, further comprising more than one gas supply, wherein each gas supply is connected to the gas supply hardware, the monitoring network and to the control system, and further wherein the control system is able to control a concentration of each gas in each of the multiple air-locks.

4. The system of claim 1, wherein the atmospheric environment is between 0.7 and 20 atmospheres, and the control system further comprises a permanent storage device and the treatment program is stored on the permanent storage device.

5. The system of claim 1, wherein the control system further comprises an Internet connection and a remote control software module that allows a remotely located computer to access and control the system via the Internet.

6. The system of claim 1, wherein the enclosure includes at least one direct delivery system for delivering a second gas from a second gas supply to a facial area of at least one patient, wherein each direct delivery system includes a direct gas supply mask that is connected to a second gas supply hardware, the second gas supply hardware being connected to the second gas supply, and wherein each direct gas supply mask is able to controllably deliver the second gas directly to the facial area of the at least one patient.

7. An apparatus that is adapted for administration of a treatment that is intended to strengthen immune systems, the apparatus comprising:
an enclosure, the enclosure having a first air-lock, the first air-lock being able to sustain a super-atmospheric environment;
a first gas supply that is connected to the enclosure, the first gas supply containing one or more gases; and,
a control system that is connected to the enclosure and the first gas supply, wherein the control system is able to control the super-atmospheric environment within the first air-lock and is able to display duration information, wherein the duration information defines the length of time for maintaining the pressure within the first air-lock.

8. The apparatus of claim 7, wherein the enclosure is a submarine and the submarine includes multiple air-locks that are capable of sustaining super-atmospheric environments.

9. The apparatus of claim 7, further comprising a trailer, wherein the apparatus is attached to the trailer, and further wherein the trailer is adapted for attachment to a vehicle so the apparatus can be moved to different locations.

10. The apparatus of claim 7, wherein more than one gas supply is connected to the enclosure and the control system is able to control a concentration of each gas in the enclosure.

11. The apparatus of claim 7, wherein the pressure is between 0.7 and 20 atmospheres, and the length of time is between 15 and 60 minutes.

12. The apparatus of claim 6, wherein the direct gas supply mask includes:
a sensor for monitoring the at least one patient; and,
a recovery hardware that is able to retrieve any of the second gas that is exhaled by the at least one patient.

13. The apparatus of claim 7, wherein the enclosure is able to hold more than 20 people.

14. A method for strengthening a patient's immune system so the patient's immune system is better able to defend the patient against a viral disease, the method comprising the steps of:
placing the patient in an enclosure, wherein the enclosure is able to withstand internal pressures up to 20 atmospheres;
filling the enclosure with at least one gas until the enclosure reaches a desired pressure; and,
having the patient remain in the enclosure, at the desired pressure, for a pre-defined length of time.

15. The method of claim 14, further comprising the step of:
releasing the at least one gas from the enclosure, in accordance with a pre-defined schedule, so that the internal pressure is safely reduced to 1 atmosphere; and,
removing the patient from the enclosure.

16. The method of claim 14, further comprising the step of:
combining another treatment, including prescribed drugs, with the method to further combat the viral disease.

17. The method of claim 14, wherein the desired pressure is between 0.7 and 20 atmospheres and wherein the pre-defined length of time is between 15 and 60 minutes.

18. The method of claim 14, wherein the step of filling the enclosure, further comprises, filling the enclosure with more than one gas.

19. The method of claim 18, wherein a concentration of each gas is at least in part determined by a treatment program.

20. The method of claim 14, wherein the step of placing the patient in the enclosure, further comprises, placing more than one patient in the enclosure, and the step of having the patient remain in the enclosure, further comprises, having the patients remain in the enclosure.
